(19) United States
(12) Patent Application Publication
(10) Pub. No.: US 2026/0266117 A1
(43) Pub. Date: Sep. 10, 2026

(54) PIVOTING A MOVABLE DOOR LEAF OF A VEHICLE DOOR

(71) Applicant: AUDI AG, Ingolstadt (DE)

(72) Inventor: Markus PETER, Reichertshofen (DE)

(73) Assignee: AUDI AG, Ingolstadt (DE)

(21) Appl. No.: 19/442,285

(22) Filed: Jan. 7, 2026

(30) Foreign Application Priority Data
Mar. 10, 2025 (DE) 102025108838.1

(51) Int. Cl. E05F 15/40; E05F 15/611

(52) U.S. Cl. CPC E05F 15/40; E05F 15/611; E05Y 2900/531

(57) ABSTRACT

A movable door leaf of a vehicle door. Depending on an actuating force exerted on the door leaf, an electric drive device is activated to influence the pivoting of the door leaf between an open position and a closed position. When influencing the pivoting of the door leaf, a movement characteristic of the door leaf is detected depending on the actuating force and compared with a predetermined movement characteristic. The predetermined movement characteristic replicates the operating force of an operator for the manual pivoting of the door leaf. Depending on the comparison result, an obstacle detection device is activated to detect obstacles within a predetermined pivoting region of the door leaf. When an obstacle is detected in the pivoting region, a collision avoidance measure is initiated by the obstacle detection device to limit an unwanted collision with the detected obstacle when the door leaf pivots.

### FIELD

The invention relates to a method for pivoting a movable door leaf of a vehicle door using an electric drive device. The invention further relates to a vehicle door system with an electric drive device for pivoting a movable door leaf of a vehicle door. Furthermore, the invention relates to a motor vehicle with at least one vehicle door and with a corresponding vehicle door system.

### BACKGROUND

There is a trend towards equipping modern vehicles with electric door drives for moving a vehicle door. The electric door drive is implemented, for example, by an electric drive device, such as with an electric motor, which can move the door between an open and closed position. There are various development stages for such a door drive.

For example, the door drive can be fully automated. In this system, the movement of the door is automatically started and stopped in response to a single user action (e.g., briefly tapping a switch). To prevent collisions with obstacles in the vicinity of the door, the fully automatic door drive is usually coupled with an obstacle detection system that can, for example, slow down the door movement.

For example, DE 10 2015 119 505 A1 discloses a door component with a controllable damping device for controllable damping of a pivoting movement of a vehicle door. The damping device can be used indirectly for obstacle detection, for example by setting a greater damping level when the door suddenly experiences a strong deceleration. This can happen, for example, if a gust of wind moves the door in the closing direction and a leg, hand, or other object is in the way.

Another development stage is the semi-automatic door drive. The operation is carried out by the user continuously operating an operating point (e.g. holding the switch). The door then moves automatically. Obstacle detection is generally not necessary here, as it is assumed that the operator has an eye on the surroundings. The responsibility for collision avoidance is therefore transferred to the operator.

A further development stage is the servo-assisted door drive. The operating action involves here the user grasping or holding the door at a specific operating point, such as the handle or another location, and performing the movement to open or close it. The drive device supports the movement desired by the operator, thus reducing the effort required by the user. This makes the door feel feather-light to the user.

The servo-assisted operation of a vehicle door is known, for example, from DE 10 2019 121 640 A1. In this process, a nominal voltage is adjusted as a function of a nominal current for an electric drive motor used to pivot a door leaf, depending on the angular velocity of the door leaf. This allows the user to maintain control over the door at all times while guiding its movement, yet the door feels feather-light. Sensors may also be provided for the door to detect whether there are any obstacles in front of the door. The door can be braked to prevent damage to the vehicle.

When using obstacle detection with a servo-assisted door drive, it can happen that the operator is detected as an obstacle. The door is then unintentionally slowed down, even though the operator actually wants to move the door further. Therefore, servo assistance is usually implemented without obstacle detection.

However, a servo-assisted door drive cannot distinguish between intentional user operation and, for example, a gust of wind, so the servo drive may start moving unintentionally. A gust of wind would therefore activate the servo-assisted mode. In extreme cases, the door will collide with an obstacle because no obstacle detection is implemented.

### SUMMARY

The object of the present invention is to realize a servo-assisted door drive that reliably responds to an operating action and avoids damage from collisions with obstacles when the vehicle door is pivoted.

Advantageous developments of the invention are disclosed by the claims, the description, and the figures.

According to an aspect, the invention relates to a method for pivoting a movable door leaf of a vehicle door. Depending on an actuating force exerted on the door leaf, an electric drive device is activated to influence the pivoting of the door leaf, at least partially, between an open position and a closed position. When influencing the pivoting of the door leaf by means of the drive device, a movement characteristic of the door leaf is detected depending on the actuating force and compared with a predetermined movement characteristic. The predetermined movement characteristic replicates the operating force of an operator for the manual or guided pivoting of the door leaf. Depending on the comparison result, an obstacle detection device is activated to detect obstacles within a predetermined pivoting region of the door leaf. When an obstacle is detected in the pivoting region, a collision avoidance measure is initiated by means of the obstacle detection device in order to limit, and in particular to avoid, an unwanted collision with the detected obstacle when the door leaf pivots.

The invention is based on the realization that the movement characteristics, i.e., a sequence of movements or a movement curve or a movement pattern, which the door leaf performs when an operator guides the door leaf, look different than when the door leaf is forced open by a disturbing event, such as a gust of wind. The comparison of this movement sequence is now used to evaluate whether obstacle detection should be switched on or can remain switched off. For example, if the movement pattern differs significantly from what an operator would expect, obstacle detection is activated. Otherwise, obstacle detection can remain deactivated. The pivoting of the door leaf is therefore carried out with obstacle monitoring as needed.

This offers the advantage that obstacle detection and, consequently, collision avoidance measures can be selectively activated when a corresponding disturbing event occurs. This effectively prevents damage to the vehicle or the obstacle. At the same time, it prevents the obstacle detection system from classifying the operator as an obstacle. This prevents unwanted braking maneuvers or similar collision avoidance measures. The servo assistance is particularly reliable.

The vehicle door could be, for example, a side door, a trunk lid and/or a frunk door or another type of vehicle door. The vehicle door or door leaf is designed as a hinged door. This means a door whose door leaf is hinged or attached to an edge using door hinges or door pivots. This type of door swings outwards around the door hinges. The door therefore moves around a pivot axis that runs along the edge where the door is attached to the vehicle body, for example, by the door hinges. In particular, there is no shifting, as is the case, for example, with a sliding door, which is usually guided or moved along two edges.

The pivoting region refers in particular to a region in which the door leaf is moved when pivoting between the open position and the closed position. The pivoting region is preferably determined by the dimensions of the door leaf depending on the abutment point on the body. The pivoting region can, for example, be a radius around the stop edge, determined by the length of the door leaf.

The open position refers to the position of the door leaf in which the door leaf is fully open. The closed position refers to the position of the door leaf in which the door leaf is fully closed. The assisted pivoting can be performed partially or completely between these two positions. This means that when pivoting, there are positions that lie between the open and closed positions.

The actuating force can be exerted by an operator, a disturbing event, or a disturbance variable. The disturbing event could be, for example, wind, especially a gust of wind, or caused by gravity, for example when parking on an inclined plane. To activate the drive device, a predetermined actuation impulse or force application is necessary. This means that a minimum force is specified to trigger the servo assistance.

To exert the actuating force, the operator can touch or hold the door leaf at any point or position, also referred to as the operating point, and then guide it in the desired direction of movement. The operating point can be, for example, a door handle, but also any other position on the door leaf.

The drive device is used for servo assistance. This reduces the force (minimum force) required to swing the door. The drive device preferably comprises an electric motor or drive motor. This is used for servo assistance, for example during servo operation, and can therefore influence, i.e. support, the pivoting movement. However, the force generated by the drive motor is not sufficient to open the door leaf on its own. This means that an additional actuating force from the outside is always necessary, for example from the operator or the disturbing event.

The use or implementation of a drive device for servo-assisted pivoting of a door leaf is known per se and is described, for example, in DE 10 2019 121 640 A1. Here, the electrical nominal voltage of the drive motor is adjusted by the motor depending on the current measured.

In this context, a movement characteristic refers in particular to a movement pattern or movement curve that represents the pivoting of the door leaf. The detected movement characteristic is compared with the nominal characteristic (predetermined movement characteristic). Tolerances are preferably taken into account during the comparison.

The invention also includes embodiments which result in additional advantages.

In one embodiment, according to the comparison result, the obstacle detection device is only activated if the detected movement characteristic deviates from a predetermined movement characteristic according to a predetermined deviation criterion.

The comparison therefore checks whether the movement characteristic deviates from the nominal characteristic to the extent of the deviation criterion. The deviation criterion specifies a measure or order of magnitude by which the detected characteristic must deviate from the nominal characteristic at least in order for the obstacle detection device to be activated. Therefore, a difference between the movement curves, as specified by the deviation criterion, must exist for the pivoting to be monitored for obstacles. The deviation criterion can be determined, for example, in test trials or simulations.

In one embodiment, according to the comparison result, the obstacle detection device remains activated only if the detected movement characteristic corresponds to the predetermined movement characteristic according to a predetermined tolerance criterion.

The comparison therefore checks whether the movement characteristic corresponds to the nominal characteristic to the extent of the tolerance criterion. The tolerance criterion therefore specifies an order of magnitude or a measure of how closely the recorded movement pattern should correspond to the nominal characteristic. Preferably, the tolerance criterion specifies a tolerance range or approximation range within which the movement patterns must lie in relation to each other in order to assume that the door movement was initiated by the operator. In particular, the tolerance criterion takes into account that, for example, different operators, such as adults or children or people of different age groups, may or will apply different operating forces when pivoting a door leaf. The tolerance criterion can be determined, for example, in test trials or simulations.

Using the deviation criterion and the tolerance criterion, the measured movement curve can thus be classified or assigned to a category. If the curve corresponds to the nominal characteristic within the tolerances, it is assigned, for example, to the category “operator”. Then it can be assumed that the operating force was exerted by the operator. This means that the operator had control over the door leaf at the time of the pivoting. If, however, the movement pattern deviates from the nominal characteristic to a given extent, this pattern is assigned, for example, to the category “disturbance variable”. Then it can be assumed that a disturbing event exerted the actuating force. The operator therefore had no control over the vehicle door, and obstacle detection is necessary.

In order to classify the movement characteristics as accurately as possible, it is advantageous to collect data on door movement under different conditions. For example, user studies can be conducted with operators, or recordings of wind events can be created.

In one embodiment, a measured variable of the drive device is recorded when the door leaf pivots in a variant for determining the movement characteristics. In another variant, a key figure for the speed of the door leaf pivoting movement is recorded additionally or alternatively. The key figure could, for example, be the angular velocity of the door leaf. For this purpose, for example a position sensor can be used, with which a position measure for an angular position of the door leaf relative to the closed position can be measured. The tolerance criterion can be determined, for example, in test trials or simulations. Additionally, the position sensor can be used, for example, to measure the speed at which the door is pivoted.

In one embodiment, the measured variable of the drive device is a current and/or a rotational speed that is set in a drive motor of the drive device when the door leaf is pivoted. This means that, for example, current ripple in the drive motor or a current-voltage profile can be determined.

The measurement of the measured variable can be carried out, for example, with a control unit of the drive motor. The control unit can, for example, have a microcontroller or microprocessor that can record and evaluate the measured variable accordingly. Alternatively, an additional sensor, such as a limit switch, a Hall sensor, a ring magnet or another type of sensor, can be used to measure the corresponding measured variable.

In one embodiment, the collision avoidance measure comprises stopping the pivoting of the door leaf by means of a braking device and/or slowing down or damping the pivoting speed of the door leaf and positioning the door leaf against the obstacle and/or moving the door leaf, depending on the position of the detected obstacle relative to the door leaf, either into the open position or the closed position, preferably by changing the direction of the pivoting movement.

To initiate or trigger the collision avoidance measure, the obstacle detection device, in particular a control unit of the obstacle detection device, can, for example, control the braking device and/or the drive device. When activated with a corresponding control signal, the braking device or the drive device performs the appropriate action to avoid or limit the collision with the obstacle.

This means that the vehicle door can be coupled with a braking device to dampen, brake or block the door leaf during the pivoting movement. The braking device could, for example, include a rotary brake or a rotary damper. Additionally or alternatively, the pivoting movement can be redirected using the braking device and the drive device, so that a change in the direction of the pivoting movement occurs.

In one embodiment, a sensor unit with at least one radar sensor and/or at least one lidar sensor and/or at least one camera and/or at least one ultrasonic sensor and/or at least one closing force sensor is used in the pivoting region for obstacle detection by means of the obstacle detection device.

This means that the sensor unit can have one or more corresponding sensors for monitoring the pivoting region. The pivoting region can therefore lie within the detection range of the respective sensor. Obstacle recognition or detection is performed using known methods or procedures. For example, environmental data is captured or measured in the pivoting region using the sensor unit and this data may be available as image data, for example. The environmental data can then be evaluated with a data processing device of the sensor unit in order to, for example, recognize or detect objects in the pivoting region and classify them as obstacles. This means that an object detection algorithm and/or object classification algorithm can be executed. The algorithm returns a result indicating whether a corresponding object classified as an obstacle is located within the pivoting region. Furthermore, the result should also include a class of the obstacle, for example, whether the obstacle was identified as bushes, a vehicle, a person, a boundary post, or another type of obstacle.

If the sensor unit includes a so-called closing force sensor, it can be used to measure external forces. This is particularly helpful if, for example, the door leaf is moving in the closing direction and the operator is located between the door leaf and the vehicle, because the operator is about to get out or unload something. The closing force sensor can detect when the door leaf touches the obstacle operator.

For applications or usage situations that can arise in the method and which are not explicitly described here, it can be provided according to the method that a fault message and/or a request for input of user feedback is output and/or a standard setting and/or a predetermined initial status are set.

According to a further aspect the invention relates to a vehicle door system for pivoting a movable door leaf of a vehicle door. The door system comprises an electric drive device, which is configured to influence, depending on an actuating force exerted on the door leaf, the pivoting of the door leaf, at least partially, between an open position and a closed position. Furthermore, a control device is provided which is designed to activate the electric drive device depending on the actuating force. The control device is also configured to detect, when influencing and pivoting the door leaf by means of the drive device, a movement characteristic of the door leaf depending on the actuating force and compare it with a predetermined movement characteristic. The predetermined movement characteristic replicates the operating force of an operator for the manual pivoting of the door leaf. Depending on the comparison result, the control device is also configured to activate an obstacle detection device to detect obstacles within a predetermined pivoting region of the door leaf. The obstacle detection as a device is configured to initiate, when an obstacle is detected in the pivoting region, a collision avoidance measure in order to limit an unwanted collision with the detected obstacle when the door leaf pivots.

This means that the vehicle door system according to the invention can execute or perform the method according to the invention. In particular, the vehicle door system according to the invention performs the method according to the invention.

In this application, the terms “control unit” or “control apparatus” or “control device” are used synonymously. The control device can have a data processing device or a processor device (processor circuit) which is configured to carry out an embodiment of the method according to the invention. For this purpose, the processor device can have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as a microprocessor. Furthermore, the processor device can have program code which is configured to carry out the embodiment of the method according to the invention when it is executed by the processor device. The program code can be stored in a data memory of the processor device. The processor device can be based, for example, on at least one circuit board and/or at least one SoC (System on Chip).

The program code is stored, for example, on a computer-readable storage medium. When the program code is executed by a computer or a computer network, it is caused to execute an embodiment of the method according to the invention. The storage medium can be provided, for example, at least partially as a non-volatile data memory (such as a flash memory and/or as an SSD—solid state drive) and/or at least partially as a volatile data memory (such as a RAM—random access memory). The storage medium can be arranged in the computer or computer network. However, the storage medium can also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (such as C) and/or as a program script (such as Python). The computer-readable storage medium can alternatively be implemented by a signal containing computer-readable data, e.g., a time-varying voltage signal and/or a radio signal.

According to a further aspect, the invention relates to a motor vehicle with at least one vehicle door and with a corresponding vehicle door system for the vehicle door. This means that the motor vehicle can have one or more vehicle doors with a respective vehicle door system by means of which the method according to the invention can be carried out or performed.

The motor vehicle according to the invention is preferably designed as an automobile, in particular as a passenger car or truck, or as a passenger bus or motorcycle.

The invention also comprises developments of the motor vehicle according to the invention and of the vehicle door system according to the invention, which have features as already described in the context of the developments of the method according to the invention. For this reason, the corresponding refinements of the motor vehicle according to the invention and the vehicle door system according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic representation of a motor vehicle with a vehicle door system for servo-assisted pivoting of a movable door leaf of a vehicle door; and

FIG. 2 shows a schematic method flow diagram for a method for pivoting the movable door leaf of the vehicle door; and

FIG. 3 shows a schematic representation of exemplary movement characteristics that can occur when pivoting the door leaf depending on an actuating force.

### DETAILED DESCRIPTION

The exemplary embodiments explained below are preferred embodiments of the invention. In the exemplary embodiments, the described components of the embodiments each represent individual features of the invention to be considered independently of one another, which each also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, same reference numerals respectively designate elements that have the same function.

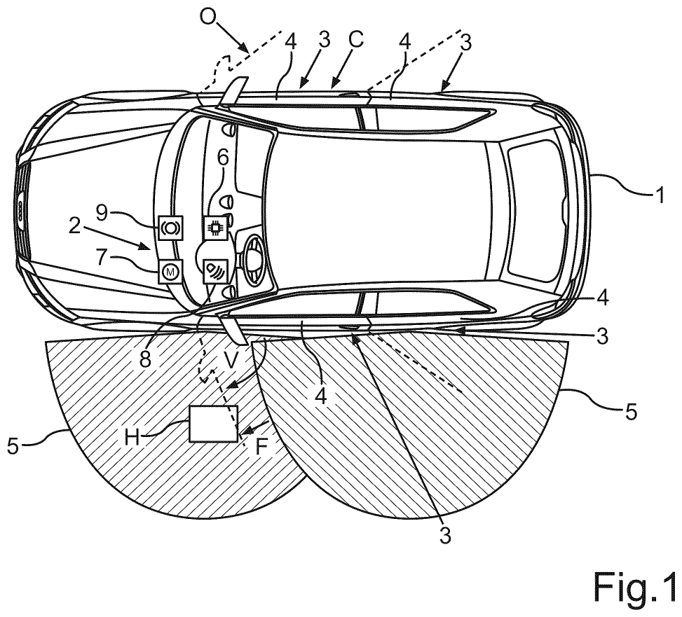

FIG. 1 shows a schematic top view of a motor vehicle 1. The motor vehicle 1 is shown, for example, as a passenger car. The motor vehicle 1 comprises multiple vehicle doors 3, which are shown here, for example, as side doors or passenger doors. Of course, another type of vehicle door, such as a trunk lid or frunk door, may also be provided. The respective vehicle door 3 is designed as a hinged door or a swing door. Its door leaf 4 is therefore only attached to the body at one edge by means of door hinges, so that the door leaf 4 rotates out, when the vehicle door performs a pivoting movement V around the door hinges.

The motor vehicle 1 also comprises a vehicle door system 2 for servo-assisted pivoting or moving of the respective door leaf 4. In the present exemplary embodiment, for the sake of clarity, only one vehicle door system for one of the vehicle doors 3 is shown. The motor vehicle 1 can of course comprise several such vehicle door systems 2, for example one for each vehicle door 3. Alternatively, it is conceivable, for example, that several vehicle doors 3 share one or more components of a vehicle door system 2. The vehicle door system 2 comprises as components here, by way of example, a control unit 6, an electric drive device 7, an obstacle detection unit 8, and a braking unit or damping unit 9.

The drive device 7 provides servo assistance when pivoting the door leaf 4. The drive device 7 comprises for example a drive motor or an electric motor. The servo assistance works as follows: If an actuating force F, i.e., a predetermined actuating impulse with a certain force, is exerted on the door leaf 4, the drive device 7, in particular the electric motor, is activated and influences the pivoting of the door leaf 4. In doing so, the door leaf 4 is moved at least partially between an open position O and a closed position C. The drive device 7 thus supports the pivoting, so that the force required as the actuating force F to open or close the vehicle door 3 is reduced.

The actuating force F can, for example, be exerted by an operator not shown. For this purpose, the operator can grasp the door leaf 4 at any operating point, such as a door handle, and move it in the desired direction to pivot. The operator therefore performs the pivoting movement V.

Alternatively, the actuating force F may be applied by a disturbing event. The disturbing event could be, for example, a gust of wind. Another type of disturbing event is caused, for example, by gravity, if the motor vehicle 1 is parked on a slope.

The control device 6 is provided to activate the drive device 7 depending on the actuating force F. The control unit 6 can therefore detect the actuating force F and then switch on the servo assistance. The detection of the actuating force F can be determined, for example, using a measurement parameter of the drive device 7. The measured variable is formed in the electric motor when the door leaf 4 is subjected to the actuating force F. The measured variable is, for example, the rotational speed or current, or voltage of the electric motor. Alternatively, it is conceivable, for example, to use a position sensor to record a characteristic value for the speed of the door leaf 4, i.e., for example an angular velocity, as a measured variable M.

The control unit 6 can, for example, be implemented as a data processing device or computing unit. It can, for example, comprise one or more microcontrollers or microprocessors.

The obstacle detection device 8 comprises a sensor unit with at least one sensor. In the present exemplary embodiment, the sensor is designed, for example, as a radar sensor. Alternatively, for example a lidar sensor, a camera, an ultrasonic sensor and/or a closing force sensor can be provided. The obstacle detection device 8 is intended to monitor a pivoting region 5 of the door leaf 4. The aim is to detect and, if necessary, classify obstacles within the pivoting region 5. This should at least limit or even prevent a collision with a corresponding obstacle H if necessary.

The pivoting region 5 refers to a region which the door leaf 4 can occupy when pivoting between the closed position C and the open position O. In order to monitor the pivoting region 5, the respective sensor is attached to the motor vehicle 1 in such a way that the pivoting region 5 lies within the detection range of the respective sensor unit.

For obstacle detection and/or classification, the obstacle detection device 8 can, for example, execute or perform an object detection algorithm and/or an object classification algorithm. For this purpose, the obstacle detection device 8 can, for example, process an environment image that depicts at least the pivoting region 5 in a known manner in order to identify individual objects in the image. For this purpose, the image is divided into regions, for example, which are then examined for features in order to be able to assign the image section or image region to a class of objects. In this case, one object class could be the class “obstacle”. In this case, any object that causes damage or injury upon collision with the door leaf can be considered an obstacle H. In the exemplary embodiment shown in FIG. 1, the obstacle H is represented, for example, as a boundary post. Of course, it can also include other types of obstacle H, such as a bush, a person, another vehicle, and so on.

The braking device 9 is designed to dampen, brake or block the pivoting movement of the door leaf 4. The braking device 9 could, for example, comprise a rotary brake or a rotary damper. The braking device 9 can therefore be used to carry out a collision avoidance measure if, for example, the obstacle detection device 8 detects an obstacle H in the pivoting region 5. This prevents an unwanted collision of the door leaf 4 with the obstacle H, or allows it to be carried out in a controlled manner, for example. This will prevent damage to vehicle 1 or obstacle H.

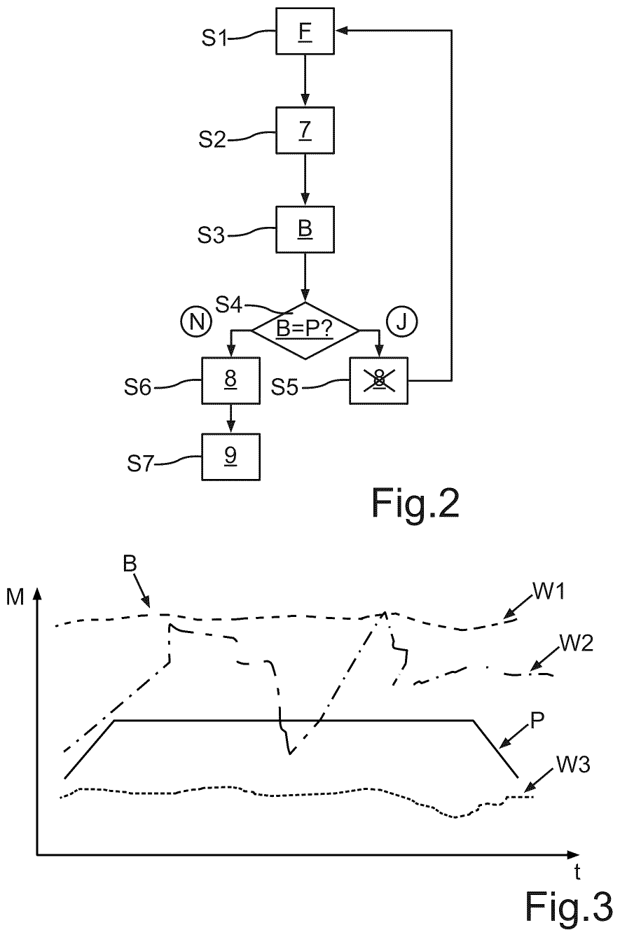

With the described vehicle door system 2, it should now be possible to intelligently use obstacle detection during servo-assisted pivoting of the door leaf 4. FIG. 2 shows a schematic exemplary method flow diagram for a method for servo-assisted pivoting the movable door leaf 4 of a vehicle door 3.

In step S1, for example, the actuating force F is first detected by means of the control device 6, as described. Regardless of whether the actuating force F is initially exerted by an operator or by a disturbing event, the electric drive device 7 is activated in a step S2. By activating the drive device 7, the pivoting of the door leaf 4 between the open position O and the closed position C is influenced. The drive device 7 supports the pivoting, in particular, as long as the actuating force F is exerted on the door leaf 4.

In step S3, a movement characteristic B of the door leaf 4 is then recorded, which depends on the actuating force F. Of course, the force exerted on the door leaf by the servo assistance also plays a role in the movement characteristics. However, since this force is set based on the actuating force F, only the actuating force F is relevant for the movement characteristic B.

To determine the movement characteristic B, the measured variable M of the drive device 7 is detected when the door leaf 4 is pivoted. The detection can be carried out, for example, using the control unit 6, as described above. For this purpose, the control unit 6 can, for example, measure the current and/or the rotational speed that occurs in the drive motor of the drive device 7 when the door leaf 4 is pivoted. As an alternative to detection with the control unit 6, for example additional measuring sensors with a corresponding sensor can be provided. For example, a Hall sensor or a ring magnet can be used for this purpose. Alternatively, a limit switch can be used, for example. Alternatively, it is conceivable, for example, to detect the angular velocity of door leaf 4 using a position sensor.

In step S4, the control unit 6 compares the detected movement characteristic B with a predetermined movement characteristic. The predetermined movement characteristic is a predetermined characteristic that occurs when an operator applies the actuating force F during the guided pivoting of the door leaf 4. That is, the reference used is the pivoting of the door leaf 4 guided by an operator and not the influence of a disturbing event. This assumes that the movement characteristics of an operator differ sufficiently from the movement characteristics of a disturbing event.

FIG. 3 shows various curves as examples, illustrating the movement characteristics based on different triggers. The curves shown in FIG. 3 are plotted in an exemplary measured variable-time diagram. The measured variable M is plotted on the y-axis, while time t is plotted on the x-axis. Alternatively, it is also conceivable to specify, for example, the opening angle of door leaf 4 on the x-axis, while the angular velocity of door leaf 4 is shown on the y-axis.

For example, FIG. 3 shows four different curves for movement characteristics B. The solid curve shows an operator movement characteristic P. The other curves show, for example, movement characteristics B, which occur due to wind speeds of varying intensity, for example, according to the Beaufort scale. A first wind movement characteristic W1 represents the curve for a strong gust of wind (shown as a dashed line). A second wind movement characteristic W2 (shown with a dashed line) shows a movement curve that occurs in winds with gusts or bursts of wind. A third wind movement characteristic, W3, shows, for example, a curve that develops in low or light wind conditions (shown as a dotted line). As can be seen from FIG. 3, the wind movement characteristics W1, W2, W3 differ significantly from the operator movement characteristic P. The operator movement characteristic is considerably more constant than those that occur in windy conditions. The wind curves show that a gust of wind can, for example, open door leaf 4 much faster or push it open much more slowly than an operator.

To collect the relevant curves, tests or simulations can be carried out, for example. For example, user studies with customers or records of wind events can be used to determine the respective movement characteristic B. The person-movement characteristic P is now used as the predetermined movement characteristic or predetermined characteristic and is used for comparison according to step S4.

If the comparison in step S4 reveals that the recorded movement characteristic B corresponds to the operator movement characteristic P preferably according to a predetermined tolerance criterion (J), the method is continued in step S5. The tolerance criterion specifies, in particular, an approximation range within which the detected movement characteristic B should lie relative to the nominal characteristic, so that the control unit 6 evaluates the movement characteristic B as being identical.

In step S5, the obstacle detection device 8 remains deactivated. This assumes that the operator guides the door leaf when it swings. The operator is therefore responsible for the door movement and is himself responsible for avoiding collisions with an obstacle H.

If the comparison in step S4 reveals on the other hand that the recorded movement characteristic B does not correspond with the nominal characteristic (N), the method is continued in step S6. In particular, step S4 checks whether the movement characteristic B deviates from the nominal characteristic according to a predetermined deviation criterion. The deviation criterion specifies a deviation range of the movement characteristic B relative to the nominal characteristic, if this range is exceeded the recorded movement characteristic B is classified as different from the nominal characteristic.

In step S6, the obstacle detection device 8 is then activated by the control unit 6. The obstacle detection device 8 then performs the obstacle detection as described above. If the obstacle detection device 8 detects a corresponding obstacle H in the pivoting region 5, the obstacle detection device 8 initiates the collision avoidance measure. For example, the obstacle detection device 8 controls the braking device 9. In step S7, the braking device 9 executes the collision avoidance measure. This means that, for example, the door leaf 4 is slowed down or dampened in its pivoting region.

Overall, the exemplary embodiments thus show the forced opening of an electrically driven vehicle door 3 by disturbances, such as wind.

1. A method for pivoting a movable door leaf of a vehicle door, wherein, depending on an operating force exerted on the door leaf, an electric drive device for influencing the pivoting of the door leaf is activated at least partially between an open position and a closed position,
wherein when the door leaf is pivoted influenced by means of the drive device, a movement characteristic of the door leaf is detected depending on the actuating force and compared with a predetermined movement characteristic, wherein the predetermined movement characteristic replicates the actuating force of an operator for manually pivoting the door leaf, and depending on the comparison result, an obstacle detection device is activated to detect obstacles in a predetermined pivoting region of the door leaf, wherein when an obstacle is detected in the pivoting region by the obstacle detection device a collision avoidance measure is initiated to limit an unwanted collision with the detected obstacle when pivoting the door leaf.

2. The method according to claim 1, wherein according to the comparison result, the obstacle detection device is only activated if the detected movement characteristic deviates from the predetermined movement characteristic according to a predetermined deviation criterion.

3. The method according to claim 1, wherein, according to the comparison result, the obstacle detection device remains deactivated only if the detected movement characteristic matches the predetermined movement characteristic according to a predetermined tolerance criterion.

4. The method according to claim 1, wherein a measured variable of the drive device and/or a characteristic value for a speed when pivoting the door leaf is detected to determine the movement characteristic.

5. The method according to claim 4, wherein the measured variable is a current and/or a rotational speed which is set in a drive motor of the drive device when the door leaf is pivoted.

6. The method according to claim 1, wherein the collision avoidance measure comprises stopping the door leaf by a braking device and/or slowing down the pivoting speed of the door leaf and applying the door leaf against the obstacle and/or moving the door leaf either into the open position or the closed position depending on the position of the detected obstacle relative to the door leaf.

7. The method according to claim 1, wherein a sensor unit with at least one radar sensor and/or at least one lidar sensor and/or at least one camera and/or at least one ultrasonic sensor and/or at least one closing force sensor is used for obstacle detection by the obstacle detection device in the pivoting range.

8. A vehicle door system for pivoting a movable door leaf of a vehicle door, comprising
an electric drive device designed to influence the pivoting of the door leaf at least partially between an open position and a closed position depending on an actuating force exerted on the door leaf, and
a control device designed to activate the electric drive device depending on the operating force,
the control device is designed to detect, when the door leaf is pivoted influenced by means of the drive device, a movement characteristic of the door leaf depending on the actuating force and compare it with a predetermined movement characteristic, wherein the predetermined movement characteristic replicates the actuating force of an operator for manually pivoting the door leaf, and to activate, depending on the comparison result, an obstacle detection device to detect obstacles in a predetermined pivoting region of the door leaf, and the obstacle detection device is designed to initiate, when an obstacle is detected in the pivoting region a collision avoidance measure to limit an unwanted collision with the detected obstacle when pivoting the door leaf.

9. Motor vehicle with at least one vehicle door and with a vehicle door system according to claim 8.

10. The method according to claim 2, wherein, according to the comparison result, the obstacle detection device remains deactivated only if the detected movement characteristic matches the predetermined movement characteristic according to a predetermined tolerance criterion.

11. The method according to claim 2, wherein a measured variable of the drive device and/or a characteristic value for a speed when pivoting the door leaf is detected to determine the movement characteristic.

12. The method according to claim 3, wherein a measured variable of the drive device and/or a characteristic value for a speed when pivoting the door leaf is detected to determine the movement characteristic.

13. The method according to claim 2, wherein the collision avoidance measure comprises stopping the door leaf by a braking device and/or slowing down the pivoting speed of the door leaf and applying the door leaf against the obstacle and/or moving the door leaf either into the open position or the closed position depending on the position of the detected obstacle relative to the door leaf.

14. The method according to claim 3, wherein the collision avoidance measure comprises stopping the door leaf by a braking device and/or slowing down the pivoting speed of the door leaf and applying the door leaf against the obstacle and/or moving the door leaf either into the open position or the closed position depending on the position of the detected obstacle relative to the door leaf.

15. The method according to claim 4, wherein the collision avoidance measure comprises stopping the door leaf by a braking device and/or slowing down the pivoting speed of the door leaf and applying the door leaf against the obstacle and/or moving the door leaf either into the open position or the closed position depending on the position of the detected obstacle relative to the door leaf.

16. The method according to claim 5, wherein the collision avoidance measure comprises stopping the door leaf by a braking device and/or slowing down the pivoting speed of the door leaf and applying the door leaf against the obstacle and/or moving the door leaf either into the open position or the closed position depending on the position of the detected obstacle relative to the door leaf.

17. The method according to claim 2, wherein a sensor unit with at least one radar sensor and/or at least one lidar sensor and/or at least one camera and/or at least one ultrasonic sensor and/or at least one closing force sensor is used for obstacle detection by the obstacle detection device in the pivoting range.

18. The method according to claim 3, wherein a sensor unit with at least one radar sensor and/or at least one lidar sensor and/or at least one camera and/or at least one ultrasonic sensor and/or at least one closing force sensor is used for obstacle detection by the obstacle detection device in the pivoting range.

19. The method according to claim 4, wherein a sensor unit with at least one radar sensor and/or at least one lidar sensor and/or at least one camera and/or at least one ultrasonic sensor and/or at least one closing force sensor is used for obstacle detection by the obstacle detection device in the pivoting range.

20. The method according to claim 5, wherein a sensor unit with at least one radar sensor and/or at least one lidar sensor and/or at least one camera and/or at least one ultrasonic sensor and/or at least one closing force sensor is used for obstacle detection by the obstacle detection device in the pivoting range.
